(19) United States
(12) Patent Application Publication
(10) Pub. No.: US 2010/0119131 A1
(43) Pub. Date: May 13, 2010

(54) EXPERT SYSTEM AND METHOD WITH REGISTRY FOR INTERPRETING ADVANCED VISUALIZATION IMAGES

(76) Inventor: Dan GEBOW, San Francisco, CA (US)

Correspondence Address: GLENN PATENT GROUP, 3475 EDISON WAY, SUITE L, MENLO PARK, CA, 94025, US

(21) Appl. No.: 12/615,230

(22) Filed: Nov. 9, 2009

Related U.S. Application Data
(60) Provisional application No. 61/112,577, filed on Nov. 7, 2008.

(51) Int. Cl. G06K 9/00

(52) U.S. Cl. 382/128

(57) ABSTRACT

An expert system for interpreting advanced visualization images aids physicians in interpretation. A reading physician can enter any of thousands of commonly-occurring findings. An embodiment finds application in interpreting Cardiac CT Angiography. The expert program includes a graphical user interface (GUI) that allows the physician to enter his findings, the software automatically formatting the findings as a patient record. The expert system performs a rule-based analysis of the findings, incorporating expert knowledge captured from experts in the field of CCTA interpretation. Registry-aided diagnosis queries a patient registry based on the findings and reports the result of the query back to the reading physician, providing valuable diagnostic guidance, greatly increasing accuracy of the diagnosis. The rulebase is continually updated, adding rules as scientific discoveries shed light on clusters of findings. As patient data is generated, the data is anonymized and transmitted to a central server for deposit in the registry.

### CROSS REFERENCE TO RELATED APPLICATIONS

This Application claims benefit of U.S. provisional patent application Ser. No. 61/112,577, filed Nov. 7, 2008 and bearing attorney docket no. MMDX0001PR, the entirety of which is incorporated as if fully set forth herein by this reference thereto.

### BACKGROUND OF THE INVENTION

1. Field of the Invention

In general, the invention relates to diagnostic imaging. More particularly, the invention relates to an expert system and method with registry for interpreting advanced visualization images.

2. Technical Background

Computerized tomography, or “CT”—is a computerized imaging technology capable of producing images of a patient's body that visualize internal structures in cross section rather than the overlapping images typically produced by conventional X-ray exams. Unlike conventional X-ray exams, which use a stationary X-ray machine to focus beams of radiation on a particular area of the patient's body to produce two-dimensional images, CT uses an X-ray unit that rotates around the patient's body, which enables gathering a large volume of projection data from multiple directions. The projection data is input to a tomographic reconstruction computer program in order to reconstruct the cross-sectional images from the projection data. CT can produce images that clearly reveal the bones and organs, as well as their inner structure and detailed anatomy. Newer reconstruction programs running on 3D workstations are capable of rendering three-dimensional images.

CT angiography (CTA) is a computed tomography technique that is used to visualize arterial and venous structures throughout the body. CTA provides a minimally-invasive imaging modality that enables physicians to examine, for example, the coronary, pulmonary and renal arteries, the aorta and the peripheral arteries, thus, making it possible to diagnose, for example, pulmonary embolism, aneurysms, aortic dissection and numerous other serious and life-threatening afflictions involving the blood vessels.

Cardiac CT angiography (CCTA) focuses on the heart and its surrounding blood vessels. Physicians use these images to help diagnose coronary artery disease and other cardiac pathologies and to estimate a patient's future risk of heart disease.

### SUMMARY

An expert system for interpreting advanced visualization images aids physicians in interpretation. A reading physician can enter any of thousands of commonly-occurring findings. An embodiment finds application in interpreting Cardiac CT Angiography. The expert program includes a graphical user interface (GUI) that allows the physician to enter his findings, the software automatically formatting the findings as a patient record. The expert system performs a rule-based analysis of the findings, incorporating expert knowledge captured from experts in the field of CCTA interpretation. Registry-aided diagnosis queries a patient registry based on the findings and reports the result of the query back to the reading physician, providing valuable diagnostic guidance, greatly increasing accuracy of the diagnosis. The rulebase is continually updated, adding rules as scientific discoveries shed light on clusters of findings. As patient data is generated, the data is anonymized and transmitted to a central server for deposit in the registry.

### BRIEF DESCRIPTION OF THE DRAWINGS

FIG. 1 provides a diagram of a machine in the exemplary form of a computer system within which a set of instructions, for causing the machine to perform any one of the methodologies discussed herein below, may be executed;

FIG. 2 provides an architecture diagram of an expert system with registry for interpreting advanced visualization images;

FIG. 3 provides a flow diagram of a method of using the system of FIG. 2;

FIG. 4 provides a flow diagram of a method of luminary and registry-aided diagnosis practiced on the system of FIG. 2;

FIG. 5 provides a screen shot of a patient list displayed in a graphical user interface (GUI) to the system of FIG. 2;

FIG. 6 provides a screen shot of a form for entering patient data displayed in the GUI to the system of FIG. 2;

FIG. 7 provides a screen shot of a form for entering non-coronary findings displayed in the GUI to the system of FIG. 2;

FIGS. 8a-c provide screen shots of a form for entering coronary findings displayed in the GUI to the system of FIG. 2;

FIGS. 9a-b provide screen shots of a form for entering bypass findings displayed in the GUI to the system of FIG. 2;

FIG. 10 provides a chart of coronary artery segments;

FIG. 11 provides a screen of a form for entering patient history with flags superimposed that refer to particular rules from the medical logic;

FIG. 12 provides a screen of a second form for entering patient history with flags superimposed that refer to particular rules from the medical logic;

FIGS. 13a-b provide screen shots of a nursing history form in the GUI to the system of FIG. 2

FIGS. 14a-d provide screen shots of a form for entering technical information concerning a scan in the GUI to the system of FIG. 2;

FIG. 15 provides a screen shot of a toolbar for configuring a custom preset in the GUI to the system of FIG. 2

FIG. 16 provides a screen shot of CT coronary angiogram report displayed in a graphical user interface (GUI) to the system of FIG. 2.

### DETAILED DESCRIPTION

An expert system for interpreting advanced visualization images aids physicians in interpretation. A reading physician can enter any of thousands of commonly-occurring findings. An embodiment finds application in interpreting Cardiac CT Angiography. The expert program includes a graphical user interface (GUI) that allows the physician to enter his findings, the software automatically formatting the findings as a patient record. The expert system performs a rule-based analysis of the findings, incorporating expert knowledge captured from experts in the field of CCTA interpretation. Registry-aided diagnosis queries a patient registry based on the findings and reports the result of the query back to the reading physician, providing valuable diagnostic guidance, greatly increasing accuracy of the diagnosis. The rulebase is continually updated, adding rules as scientific discoveries shed light on clusters of findings. As patient data is generated, the data is anonymized and transmitted to a central server for deposit in the registry.

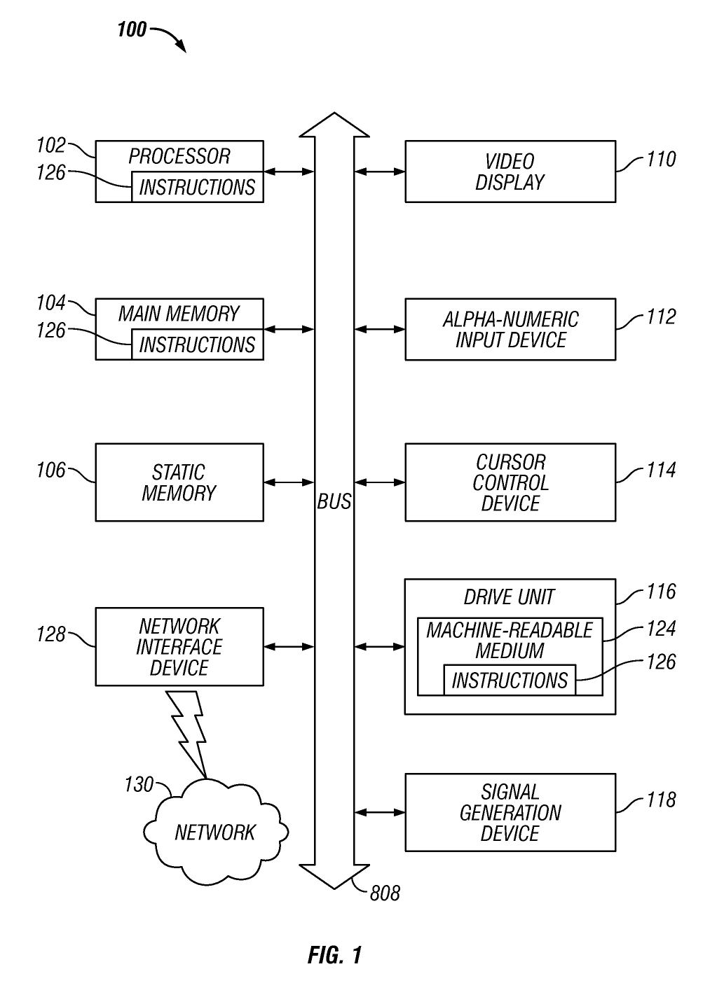

Referring now to FIG. 1, shown is a diagrammatic representation of a machine in the exemplary form of a computer system 100 within which a set of instructions for causing the machine to perform any one of the methodologies discussed herein below may be executed. In alternative embodiments, the machine may comprise a network router, a network switch, a network bridge, personal digital assistant (PDA), a cellular telephone, a web appliance or any machine capable of executing a sequence of instructions that specify actions to be taken by that machine.

The computer system 100 includes a processor 102, a main memory 104 and a static memory 106, which communicate with each other via a bus 108. The computer system 100 may further include a display unit 110, for example, a liquid crystal display (LCD) or a cathode ray tube (CRT). The computer system 100 also includes an alphanumeric input device 112, for example, a keyboard; a cursor control device 114, for example, a mouse; a disk drive unit 116, a signal generation device 118, for example, a speaker, and a network interface device 128.

The disk drive unit 116 includes a machine-readable medium 124 on which is stored a set of executable instructions, i.e. software, 126 embodying any one, or all, of the methodologies described herein below. The software 126 is also shown to reside, completely or at least partially, within the main memory 104 and/or within the processor 102. The software 126 may further be transmitted or received over a network 130 by means of a network interface device 128.

In contrast to the system 100 discussed above, a different embodiment of the invention uses logic circuitry instead of computer-executed instructions to implement interpretation of advanced visualization images. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complimentary metal oxide semiconductor), TTL (transistor-transistor logic), VLSI (very large scale integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments of this invention may be used as or to support software programs executed upon some form of processing core (such as the Central Processing Unit of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

It has been demonstrated that structured reporting of CTA (CT angiogram) and CCTA (cardiac CT angiogram) findings leads to significantly more accurate diagnosis. Codification of the findings also facilitates the ability to do research and to make the data mineable. A variety of workflows are commonly used by physicians to report CTA and CCTA findings. One of the more common workflow recording solutions is voice dictation. While dictating the initial report is fast and expedient, the dictated report requires transcription, with its associated cost. Additionally, the transcribed report must be reviewed for errors by the reporting physician, which adds significantly to the time cost of reporting findings. Additionally voice dictation is relatively unstructured and findings are not codified. Another common workflow solution is the use of a word-processing template, configured with pull-down menus, to expedite filling out the form. However, with the many possible endpoints involved in CCTA—currently more than nine thousand—reporting findings becomes exceedingly slow and cumbersome. Additionally, word-processing forms are typically minimally structured and not codified, limiting later use of the data for such purposes as benchmarking or research.

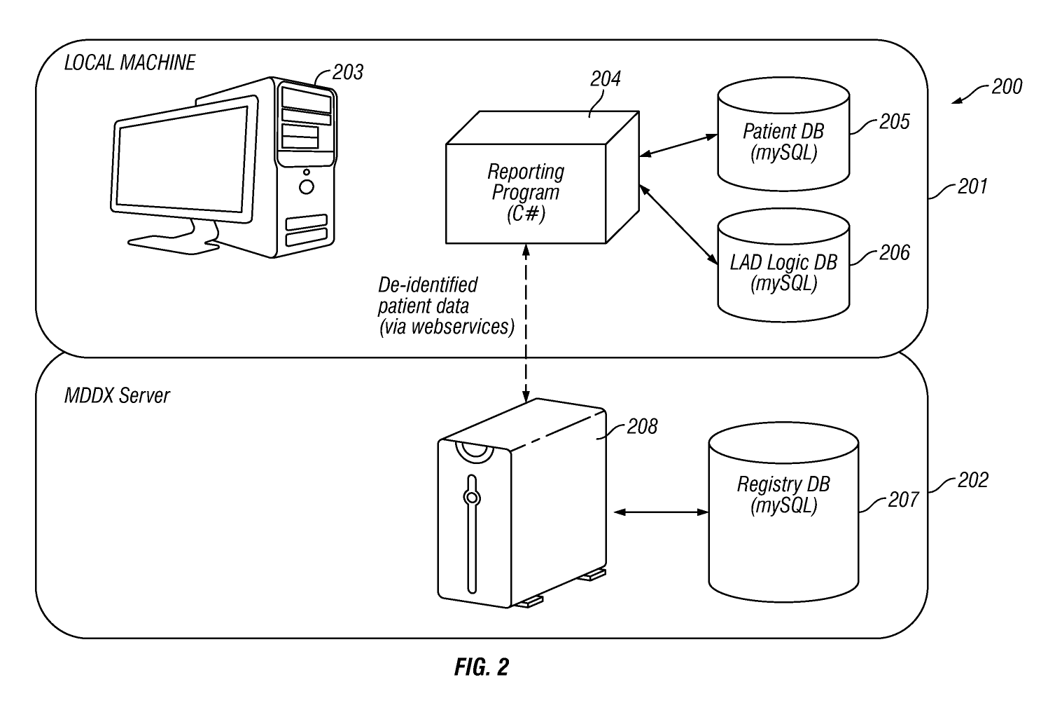

FIG. 2 provides an architecture diagram of a distributed expert system with registry 200 for interpreting advanced visualization images. In an embodiment, the expert system is an expert system for interpreting cardiac CT angiograms (CCTA). CCTA uses computed tomography to provide a three-dimensional representation of a patient's heart, allowing physicians to find and diagnose various cardiovascular pathologies, such as arterial blockages, tumors or valve defects. When a physician is interpreting a CCTA study, the reporting software 204 provides a graphical user interface (GUI), with which the physician enters and reports his/her findings. The software 204 automatically formats the physician's findings, that is, what they found in the images, into a written report, constituting a patient record. Additionally, by entering the findings into the patient record and saving the record to a patient database, the data is automatically structured and codified, greatly increasing its accessibility and utility.

As shown in FIG. 2, an embodiment of the system is a distributed system with components of the system being distributed between a client side 201 and a server side 202. Executing on a client machine 203 is a reporting program 204. The reporting program is configured to allow a physician to enter findings commonly found in an advanced visualization diagnosis. In an embodiment, the reading physician is enabled to enter over nine thousand different findings using the reporting program 204. However, the number of findings that can be reported using the software 204 is expected to rapidly increase with the knowledge base regarding CCTA interpretation, which is a relatively new addition to the panoply of diagnostic tools. Thus, the number of findings that can be reported with the reporting software is not limited and is a reflection of the state of knowledge within the medical arts. An embodiment of the reporting software 204 includes a feature that helps the reading physician refine his findings by incorporating expert knowledge in reading the images, as well as real-time querying against a large database of previously-read images. A major advantage of the reporting software 204 is a great increase in the accuracy of diagnosis, and therefore the ultimate quality of patient care. In an embodiment, the client machine is a 3D workstation upon which the CCTA data is rendered as a 3-dimensional representation of the patient's heart. In a further embodiment, the client machine is a separate computer communicatively coupled to a 3D workstation upon which the CCTA data is rendered as a 3-dimensional representation of the patient's heart.

In an embodiment, as patient records are created by the reporting program 204, each record is stored locally in a patient database 205. As mentioned above, an embodiment provides the capability of enhancing the reading physician's diagnostic ability with expert knowledge. Integrated with the reporting program 204 is a LAD (luminary-aided diagnosis) logic database 206. In an embodiment, the LAD logic database 206 constitutes a rule base containing a plurality of rules embodying the expert knowledge. Also incorporated within the reporting software is an inference module (not shown) that applies the expert rules form the LAD logic database 206 to evaluate the reading physician's findings. More will be said about the application of the medical logic to the findings herein below.

In an embodiment, patient data contained in patient records saved to the patient database 205 may remain associated to the individual patient. Additionally, patient data may be reported to the server 208 for storage in a registry database 207. In an embodiment, patient data that is saved to the registry database 207 may be queried for research purposes. In accordance with statutes protecting the confidentiality of patient data, patient data that is used in this way may be de-identified. That is, the patient data may be anonymized by stripping it of any personal data by which an individual patient could be identified. Thus, in an embodiment, the registry contains only de-identified patient data.

As above, the reporting program 204 can enhance the accuracy and quality of the reading physician's findings through the use of the luminary-aided diagnosis feature. The reporting program 204 also provides the capability of querying the registry database 207 to compare the reading physician's findings with previously-reported findings, for example, in similar patients, or in the presence of similar conditions, or in the presence of a specified set of circumstances. Thus, the system 200 provides another feature for enhancing the accuracy and quality of the reading physician's findings.

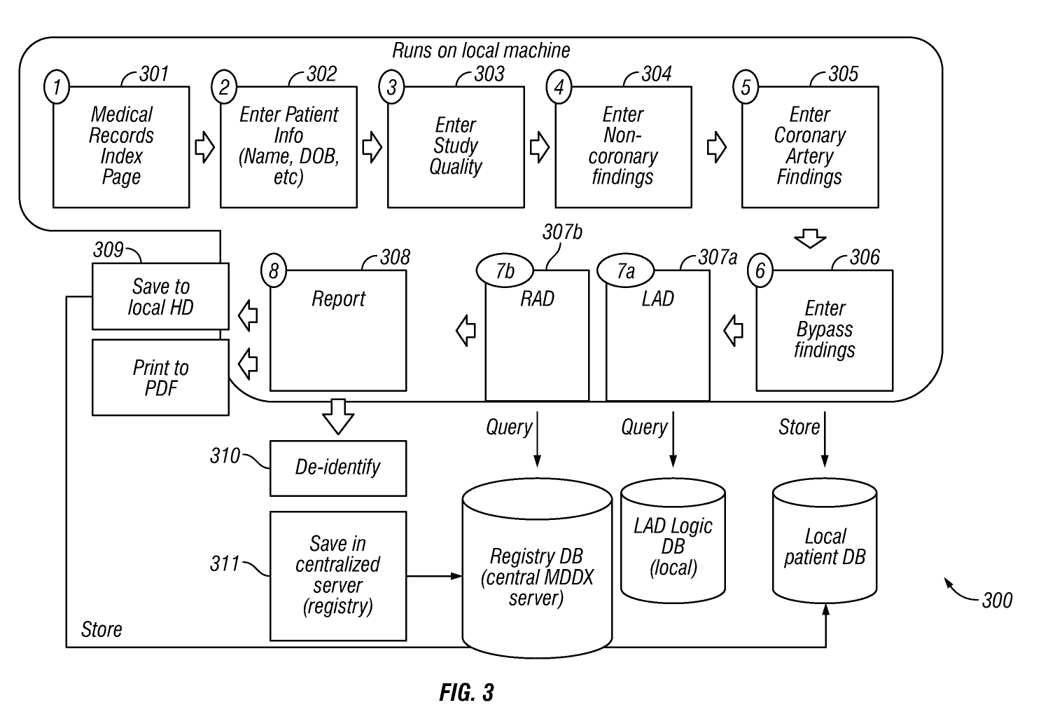

Referring now to FIG. 3, shown is a flow diagram of a method of using the system 200. A practitioner of ordinary skill will readily understand that the sequence of actions shown in FIG. 3 is merely exemplary. In actual practice, using the system 200 may vary from the following sequence of actions:

access the medical records index page (301);

enter patient info (302);

enter study quality (303);

enter non-coronary findings (304);

enter coronary findings (305);

enter Bypass findings (306);

query LAD logic database (Luminary-aided diagnosis) (307a);

query registry database (307b); and

Generating a report (308).

As shown in FIG. 3, generating the report may include actions of saving to the local database 309 and de-identifying patient data 310 and saving 311 to the registry database 207 on the central server 202. Once the report is generated, it may be printed in a selected format, for example, MICROSOFT WORD (MICROSOFT CORPORATION, Redmond Wash.) or PDF (portable document format) (ADOBE SYSTEMS, INC., San Jose Calif.). Additionally, the report can be emailed or imported into a variety of medical records systems (MRS).

The practitioner of ordinary skill will recognize that not all actions in the foregoing sequence may be taken for all patients. For example, as described in more detail below, the reading physician may not enter any non-coronary findings because none were noted. Or for another patient, no coronary findings were noted and therefore not entered. Not all patients undergoing a procedure will have had a CABG (coronary artery bypass graft), so there may be no bypass findings. Additionally, the reading physician may not use the LAD or the RAD features. Nevertheless, the foregoing procedure represents a sound example of a method for using the system 200.

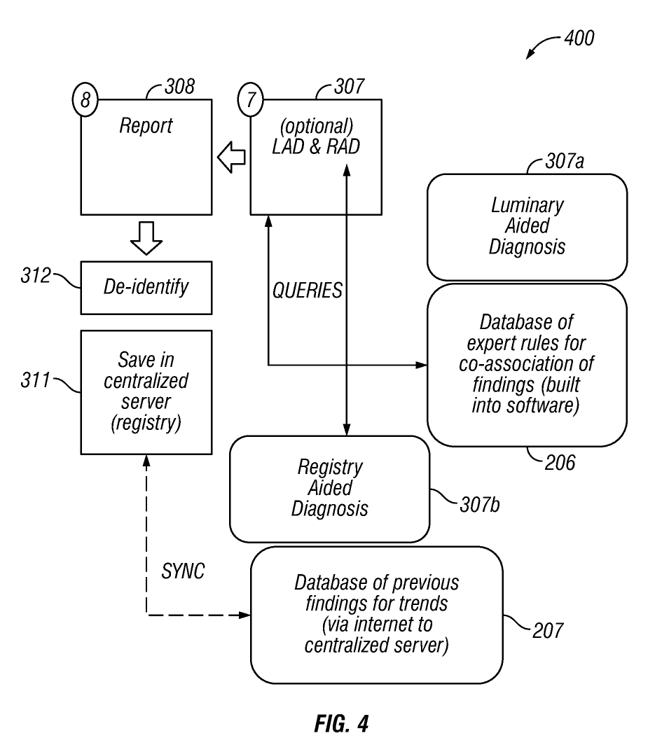

FIG. 4 shows a flow diagram of a method 400 for using the so-called “SMART” features of the reporting program 204. In an embodiment, the SMART features of the program can be deployed before the reading physician generates the report. The physician selects a GUI feature 307, for example, a button 608 in order to access the SMART features. In an embodiment, the button is identified with the icon “SMART”. Selecting the button activates program instructions that take the newly-entered physician's findings and compare them to two expert sources: Luminary-Aided Diagnosis and Registry-Aided Diagnosis.

Luminary Aided Diagnosis (LAD) 307a: The first comparison is against a series of “rules” or “trends” (i.e. medical logic) 206 that experts in CCTA have acquired in their years of reading CCTA studies; and which are integrated with the reporting software 204 in an embodiment. In a further embodiment, the medical logic 206 resides in a rulebase that is communicatively coupled to the reporting software 204. For example, embodied in the medical logic 206 as one or more rules is the expert knowledge that dead tissue in the wall of the heart muscle is, in most cases accompanied by a blocked coronary artery that is preventing blood from nourishing that part of the heart. Accordingly, when the medical logic determines that a reading physician has entered a finding of dead tissue in the wall of the heart muscle, it determines if a finding relating to a blocked coronary artery has also been entered. If it has not been entered, it prompts the reading physician to look for the blocked artery. In this way, the reading software integrates the expert knowledge. Thus, in a manner similar to that of a spell checker, if a novice physician enters a “dead tissue in the heart muscle”, it triggers the software to ask the physician if they checked for blockage of the coronary artery supplying the appropriate part of the heart with blood.

In an embodiment, the medical logic incorporates knowledge and expertise collected from a group of medical experts in CCTA and formatted into rules. Typically, such rules are formulated as conditional statements stating a premise and a conclusion. For example, using the above example of heart muscle death and coronary artery blockages, the expert knowledge may be formulated as a statement such as: if “heart muscle death”, then “coronary artery blockage”. If an inference module in the reporting software 204 determines that the premise “heart muscle death” is true for findings reported in a particular record, but also determines that the conclusion “coronary artery blockage” is false for the findings, it prompts the novice physician to look for the condition specified by the conclusion—in this case, “coronary artery blockage”. New rules can be added to the medical logic as scientific discoveries shed light on clusters of findings.

An exemplary set of rules is listed below in Table 1. The rules listed are provided only to illustrate the principles underlying the Luminary-aided diagnosis feature of the reporting software and are not intended to be limiting.

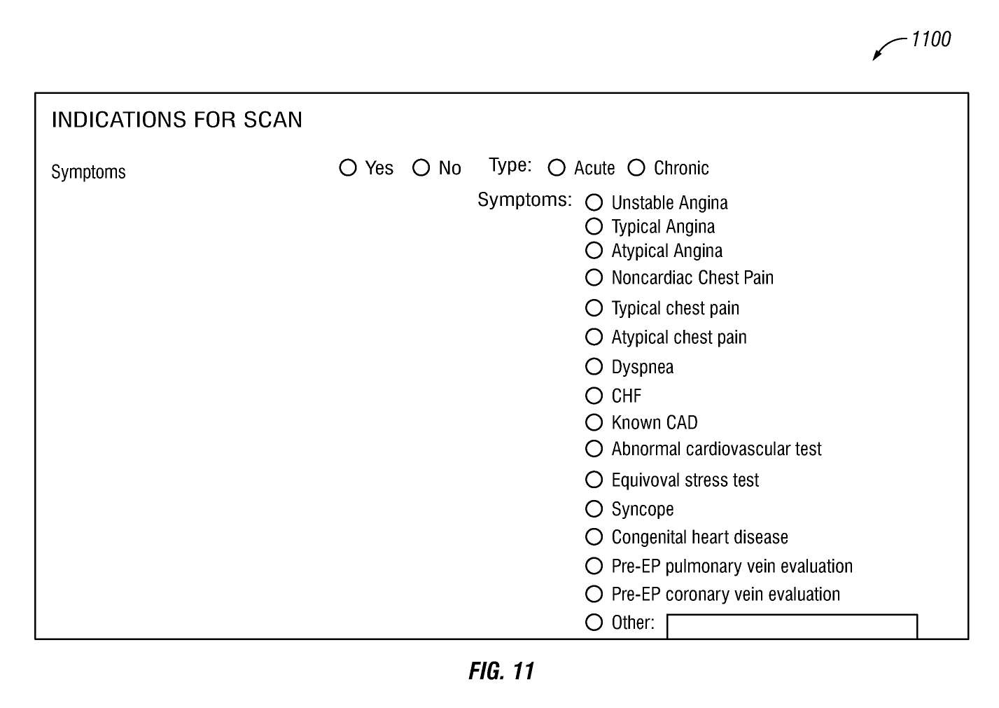

TABLE 1

| Rule | Due to . . . | Did you check for . . . ? |
|---|---|---|
| 1a | Left Atrial enlargement | left ventricular hypertrophy |
| 1b | Left Ventricle Hypertrophy | left atrial enlargement |
| 2 | Bicuspid valve | coarctation of aorta |
| 3a | Occlusion of [segment name] | collaterals |
| 3b | The fact that you checked | a severe lesion or total |
| | collaterals in the [segment name] | occlusion in that artery |
| 4a | Smart Tag: | |
| (cont'd) | Due to the fact you found an | the [name of corresponding |
| | infarct in [name of bull's-eye | coronary artery] for a |
| | sector] see FIG. 11. | lesion? |
| | Sub-rule: | |
| | (If the above rule is shown) | |
| | Due to the variability in coronary | all coronary arteries? |
| | anatomy | |
| 4b | Any severe or occluded lesion in | Signs of an infarct in the |
| | ANY coronary artery- A severe or | Myocardium of the Left |
| | occluded answer is checked in the | Ventricle? |
| | coronary artery diagram. | |
| 5a | The fact that you found a dilated | pulmonary emboli, valvular |
| | (right atrium or right ventricle) | heart disease, and shunts |
| 5b | The fact that you found pulmonary | a dilated right atrium and/or |
| | emboli | right ventricle |
| 5c | The fact that you found Valvular | a dilated right atrium and/or |
| | Heart Disease (either of those 2 | right ventricle |
| | nodes are checked: the mitral valve | |
| | appears stenotic, or the aortic valve | |
| | appears stenotic) | |
| 5c1 | The fact that you found a stenotic | left ventricular hypertrophy |
| | aortic valve | |
| 5d | The fact that you found a septal | a dilated right atrium and/or |
| | defect | right ventricle |
| 5e | The fact that you found a septal | a dilated right atrium and/or |
| | defect | right ventricle |
| 6 | The fact that you found an infarct | thrombus in that area |
| | in the apex of the myocardium | |

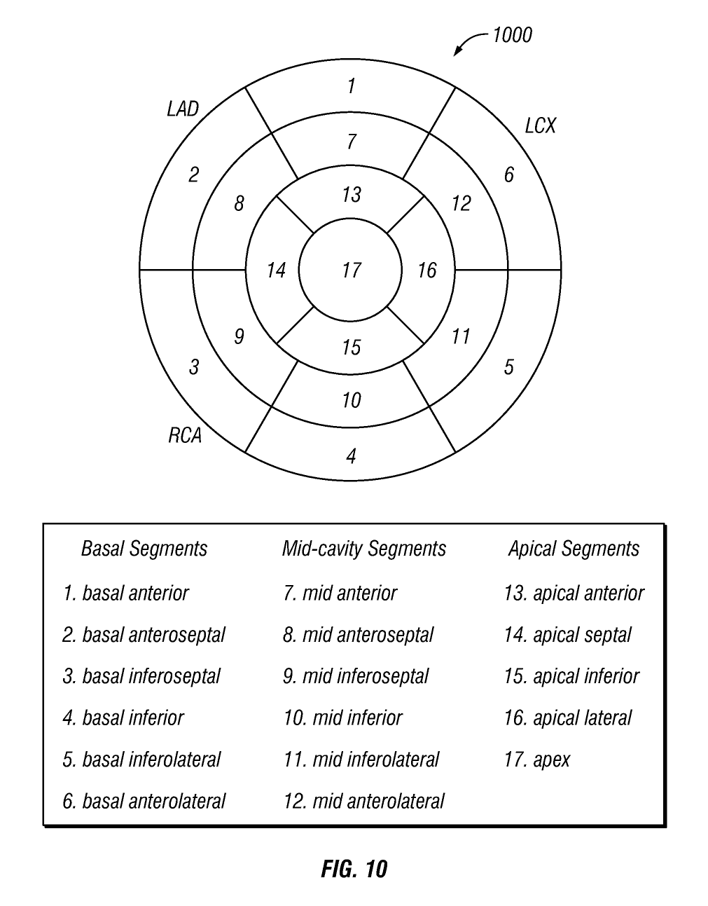

While the content of Table 1 is readily understandable by the ordinarily-skilled practitioner, wherein the left column lists the rule premise and the right column lists the rule conclusion, it should be noted that the expression “segment” enclosed by square brackets in Rules 3a and 3b is a placeholder for the name of a coronary-artery segment identified by the reading physician in the findings. The software extracts the name of the segmented entered, for example “LAD” (left anterior descending) and inserts it in place of the placeholder. The “bull's-eye sector” referred to by the placeholder in Rule 4a refers to the chart 1000 of coronary artery segments. As will be later explained, the GUI of the reporting software allows the reading physician to specify a sector of the myocardium by selecting it in an interactive representation of the chart 1000 of FIG. 10. The acronyms for the three major coronary arteries are arrayed the circumference of the chart 1000: LAD (left anterior descending), LCX (left circumflex) and RCA (right coronary). The myocardial segments are arranged within the bull's eye chart according to the coronary artery that they are mostly closely associated with anatomically. Each section within the chart bears a number. In the listing below the chart, the numbers are keyed to specific segments of the myocardium. Accordingly, the number 11 represents the mid-inferolateral segment of the myocardium.

Additionally, while the underlying rule is nearly always of the “if . . . then” type, the prompts that are displayed based on the rule may be formatted differently according to particular purpose of the UI section. For example, FIG. 11 shows a detailed view 1100 of a section for entering test indications, from the ‘Patient Info’ form 600. The medical logic includes a series of rules for evaluating the information provided by the indications selected:
If Dypsnea is checked, then show:
“Since the patient has reported dyspnea, did you look closely at the right side of the heart, lungs, and pulmonary arteries?”
If Known CAD is checked and (no answers were reported under non-coronary AND no answers were reported on the coronary arteries), then show:
“Note: You didn't find any abnormalities in the non-coronary structures or the coronary arteries, yet the patient states they have known CAD”
If CHF is checked and (no answers were reported under non-coronary AND no answers were reported on the coronary arteries), then show:
“Note: You didn't find any abnormalities in the non-coronary structures or the coronary arteries, yet the patient states they have CHF”.

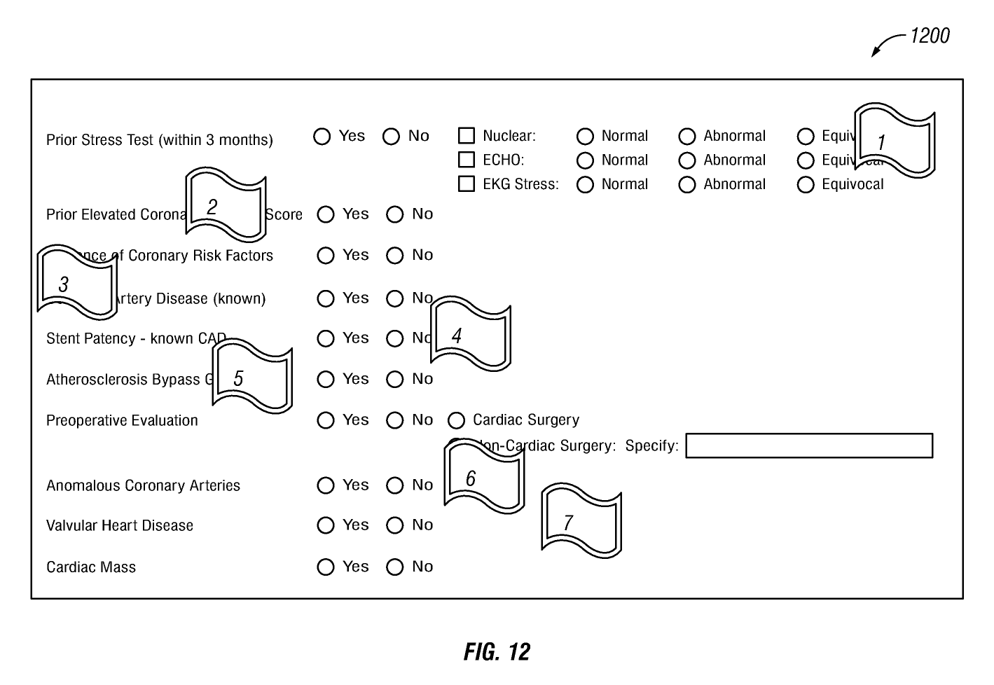

Referring to FIG. 12, shown is another view 1200 of a form 600 for entering patient history. While flags 1-7 have been superimposed on the image of the form for illustration, in actual fact, the form does not have the flags. Flags 1-7 refer to Rules 1-7 listed below:
1. a. If Yes+Nuclear+Abnormal, and (no answers were reported under non-coronary AND no answers were reported on the coronary arteries), then show:
   “Note: You didn't find any abnormalities in the non-coronary structures or the coronary arteries, yet the record indicates the patient had an abnormal nuclear stress test”
   b. If Yes+ECHO+Abnormal, and (no answers were reported under non-coronary AND no answers were reported on the coronary arteries), then show:
   “Note: You didn't find any abnormalities in the non-coronary structures or the coronary arteries, yet the record indicates the patient had an abnormal echo stress test”
   c. If Yes+EKG+Abnormal, and (no answers were reported under non-coronary AND no answers were reported on the coronary arteries), then show:
   “Note: You didn't find any abnormalities in the non-coronary structures or the coronary arteries, yet the record indicates the patient had an abnormal EKG stress test”
2. If prior elevated Coronary calcium score is YES and under coronary>>any segment>>(no answers are selected that are calcified plaque and no answers are selected that are mixed plaque), then show:
   “The patient has a prior elevated coronary calcium score, but you did not report any calcified lesions in the coronary arteries”
3. If “Coronary Artery Disease (known) is checked yes and (no answers were reported under non-coronary AND no answers were reported on the coronary arteries), then show:
   “Note: You didn't find any abnormalities in the non-coronary structures or the coronary arteries, yet the patient states they have known CAD”
4. If “stent patency” is checked yes and (no answers are given under coronary>any segment>stent 1 AND no answers are given under coronary>any segment>stent 2), then show:

“The patient record indicates a prior stent, yet you did not report on any stents in this patient”
5. If “atherosclerosis bypass graft” is checked yes and (no answers are given under BYPASS on graphic), then show:

“The patient record indicates a bypass, yet you did not report on any bypass findings”
6. If “anomalous coronary” is checked yes and (no answers are given under coronary>Dominance>anomalous coronary artery) then show:

“The patient record indicates an anomalous coronary artery, yet you did not report an anomalous coronary artery”
7. If yes on valvular heart disease, and (no answers on non-coronary>PULMONARY valve and no answers on Aortic valve and no answers on mitral valve and no answers on tricuspid valve), then:
   “The patient record indicates valvular heart disease, yet you did not report an any findings on any valve”

It will be readily recognized, for example, that rules 1a-c refer to the queries regarding “prior stress tests. As in rule 1a, if ‘yes’ for a prior stress test and ‘nuclear’ for the type of stress test and ‘abnormal’ for the result and no non-coronary or coronary findings are reported, the software displays the prompt: “Note: You didn't find any abnormalities in the non-coronary structures or the coronary arteries, yet the record indicates the patient had an abnormal nuclear stress test.” In similar manner, rule two corresponds to the rule with the “2” flag superimposed, regarding prior elevated coronary calcium score. Thus, as shown, the premise of a rule can contain several variables and different values in the variables may dictate a different conclusion. Alternately, a single-variable premise may lead to a plurality of alternate or concurrent conclusions. For example, the presence of a certain symptom, such as dyspnea, may signify one or more from a multitude of pathological conditions.

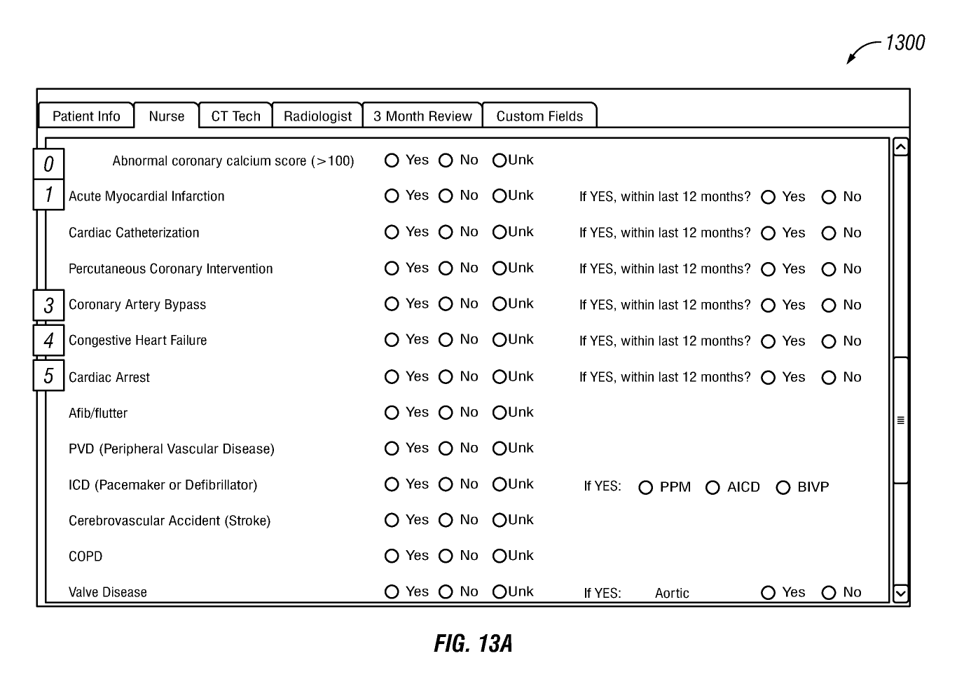

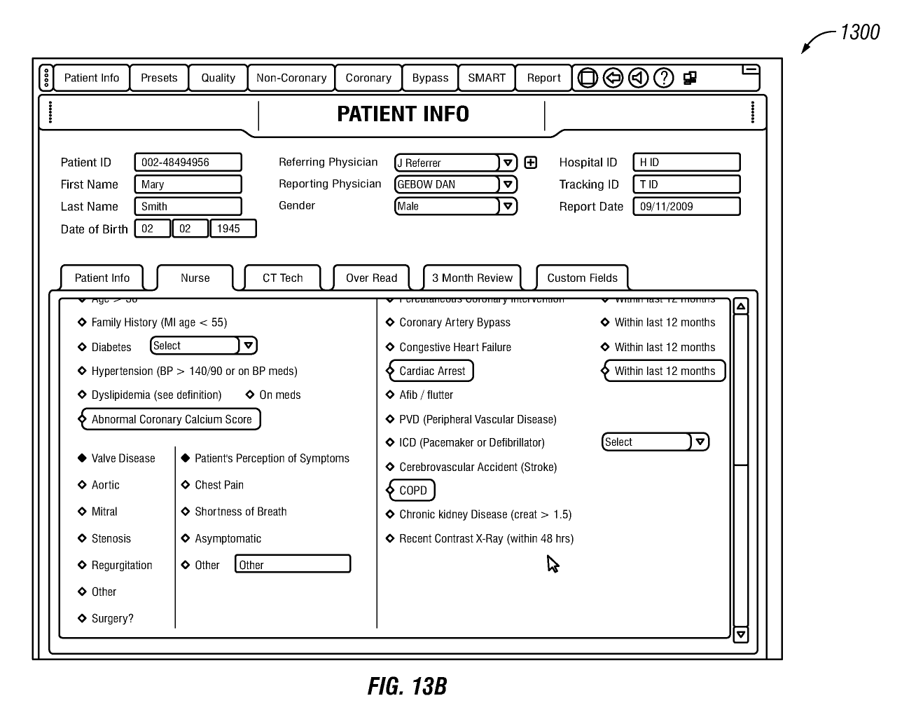

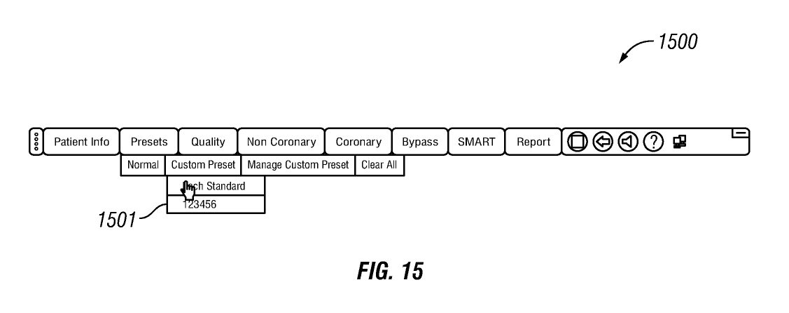

Referring to FIGS. 13a-b, different views of a form 1300 for entering a nursing history is shown. Rules 1-6 are rules applicable to the information of the nursing history form:
1. If abnormal Coronary calcium score is YES and under coronary>>any segment>>(no answers are selected that are calcified plaque and no answers are selected that are mixed plaque), then show:
“The nurse report has a prior elevated coronary calcium score, but you did not report any calcified lesions in the coronary arteries”
2. If Acute Myocardial function is YES, and non-coronary>Left Ventricle Myocardium>infarct>NO ANSWERS AT ALL
“The nurse report has a prior MI, but you did not report any findings of a prior MI in the LV myocardium”
3. If coronary artery bypass is checked YES, and (no answers are given under BYPASS on graphic), then show:
“The patient record indicates a bypass, yet you did not report on any bypass findings”
4. If Congestive Heart failure is yes, then show:
“The nurse report indicates previous CHF, did you check for MI, low ejection fraction on functional imaging, valvular heart disease, and severe coronary artery disease?”
5. If Cardiac arrest is YES, And non-coronary>Left Ventricle Myocardium>infarct>NO ANSWERS AT ALL
“The nurse report has a prior cardiac arrest, but you did not report any findings of a prior MI in the LV myocardium”;
6. If yes on valve disease, and (no answers on non-coronary>PULMONARY valve and no answers on Aortic valve and no answers on mitral valve and no answers on tricuspid valve), then:
“The nurse record indicates valvular heart disease, yet you did not report any findings on any valve.”
FIGS. 15a-d are different views of a form 1500 in the GUI for the CT technologist performing the scan to enter information directly relating to technical aspects of the skins. The following exemplary rules apply to the information fields of the CT tech form 1400:
1. If CABG=yes and (no answers are given under BYPASS on graphic), then show:
“The CT Tech record indicates a bypass, yet you did not report on any bypass findings”;
2. If Stent=yes and (no answers are given under coronary>any segment>stent 1 AND no answers are given under coronary>any segment>stent 2), then show:
“The CT record indicates a stent, yet you did not report on any stents in this patient”;
3. If under GUI Quality>Artifact>any answer (except pacemaker)>
“Due to the fact that you found artifact in the study, did the patient take beta blockers the night before?”;
4. If average HR during scan . . . is greater than 65, then show:
“Due to the fact that the patient had a high heart date during the scan, did you beta block the patient? Did the patient take the beta blocker the night before the scan?”;
5. If Prospective helical is not checked and prospective step and shoot is not checked, then show:
“The CT Tech report indicated that you are not using prospective gating techniques. You may want to consider contacting your CT vendor about ways to reduce the radiation dose”
6. If Radiation is >17 mSv,
“The CT Tech report indicated that the radiation dose to the patient is above 17 mSv. You may want to consider contacting your CT vendor about ways to reduce the radiation dose, including prospective gating techniques”;
7. If BMI >28 OR weight is >220, show:
“If you are getting low quality images in higher BMI patients, the CT tech may need to increase their mA and kVp to compensate for increased weight”; and
8. If Coronary artery calcium score >0, and (under coronary>>any segment>>(no answers are selected that are calcified plaque and no answers are selected that are mixed plaque), then show:
“The CT Tech found an elevated coronary calcium score, but you did not report any calcified lesions in the coronary arteries”.

The ordinarily-skilled practitioner will readily understand that the foregoing assortment of rules is only exemplary. Additionally, the foregoing forms are also shown as examples and are not intended to be limiting. The number and nature of rules possible within the system are a reflection of the particular application and of the state of knowledge within the medical arts.

Registry Aided Diagnosis (RAD): At the same time a patient report is generated, the data (findings) has all identifying characteristics such as Name, Address and SSN, removed. This “anonymized” data is then transmitted via a network such as the internet to a registry database 207 on a centralized server 208. In this way, if one hundred physicians are using the system 200, the reporting software 204 automatically collects the thousands of patient records from these physicians. Thus, these anonymized records comprise a large registry of CCTA patients. All the data is codified in the same manner, greatly facilitating rapid trend recognition.

The trends found in the registry have at least two uses. First, they can be used for scientific discovery. For example, one might query “All CCTA patients, aged 60-65, who are on Medication X” and look to see if they have similar findings. The secondutility is “Registry Aided Diagnosis”. Using a mechanism similar to that of “Luminary-Aided Diagnosis”, the software automatically queries the findings entered by the novice physician against the registry. As an example: If the novice physician finds dead tissue in the heart muscle, the software may report back a trend identified from the registry data: “In the registry, when there is thinning of the heart muscle, there is a 60% correlation with finding a blocked vessel and a 40% chance of finding a valve defect”. In other words, the reporting system coaches the reading physician by using the aggregate findings of all other physicians using the system in the world, or as compared to a chosen subset of expert physicians.

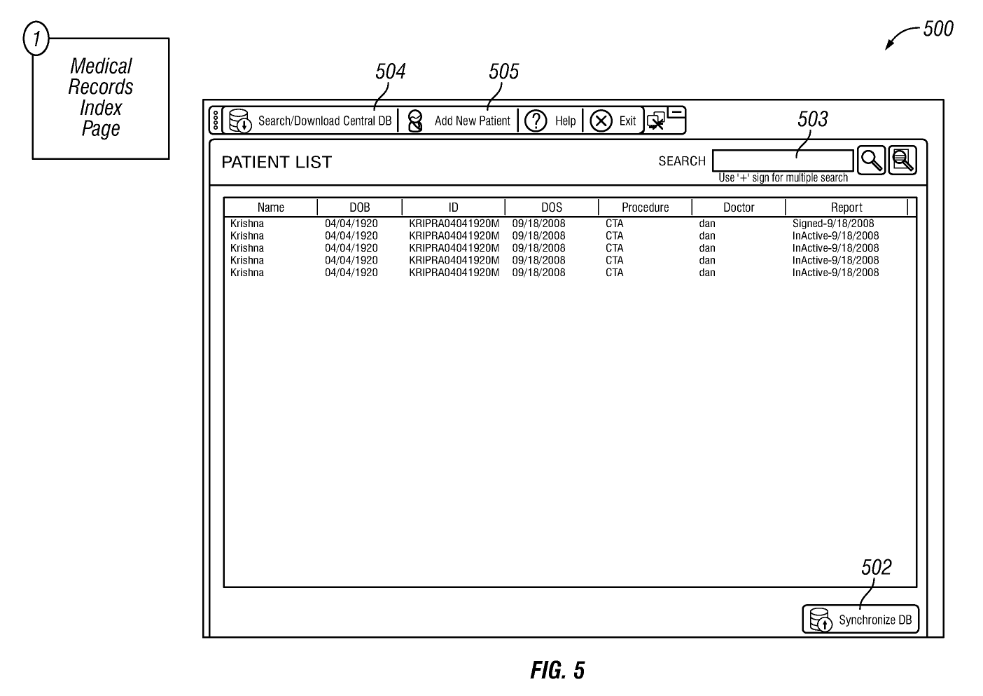

Referring now to FIG. 5, shown is a view of a medical records index page 500, displaying a patient list 501, which reflects the patient records locally stored in the patient database 205. In an embodiment, the patient list displays a predetermined number of fields from the patient records. As shown in FIG. 5, the fields displayed may include patient name, date of birth, patient ID, for example a patient number or Social Security number, the date of service (DOS), the procedure, the practitioner name and the report date.

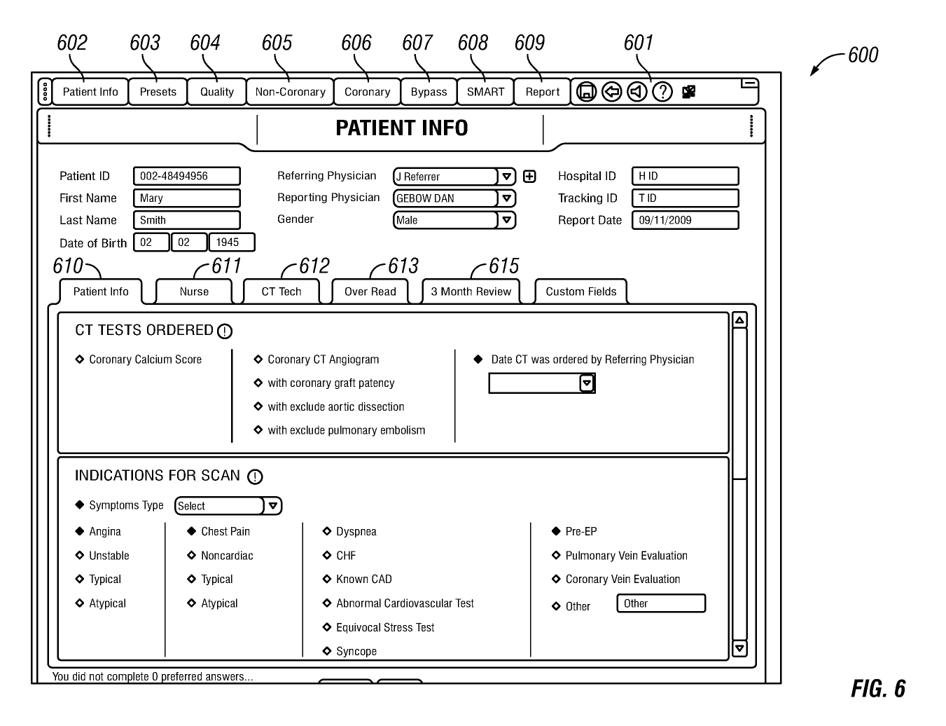

A search feature 503 allows a parametric search of patient records, for example by patient name, or by DOS (date of service). A ‘synchronize DB’ feature 502 allows the local database 205 to be synchronized with the registry database 207. An additional search feature 504 is used to search the registry 504 and to download data sets. The user accesses an existing patient record by selecting from the patient list, for example, by double-clicking the proper row in the patient list 501. An ‘add new patient’ feature 505 allows the user to create new records. Accessing an existing or adding a new patient both navigate the user to the patient info form 600 shown in FIG. 6. In the case of an existing record, the fields are populated, and in the case of a new patient, the fields are either blank or populated with default information. At the top of each page in the UI is found a toolbar 601 comprising a series of features, such as buttons or tabs, through which one gains access to the various forms that make up the user interface. One accesses the pages of the user interface by selecting their respective user interface elements. In an embodiment, the user interface elements include at least one of the following:

Patient Info (602);

Presets (603);

Quality (604);

Non-Coronary (605);

Coronary (606);

Bypass (607);

Report (608); and

SMART (609).

In an embodiment, the patient info form 600 contains fields for, for example, first name, last name, date of birth, the referring physician, which is selected from a pull-down menu; the reporting physician, also a pull-down; the gender; hospital ID, which is customizable; tracking ID which is customizable; and report date. In an embodiment, report date is automatically populated with the day on which the record is signed.

The patient info page 600 also includes a series of tabs for a number of sub-forms. In an embodiment, the tabs include:

Patient Info 610;

Nurse 611;

CT Tech 612;

613;

3-Month Review 614; and

Custom Fields 614.

More will be said about the respective sub-forms accessed through the tabs herein below.

In an embodiment, the Patient Info form 600 may include a menu 616 titled ‘CT Tests Ordered’ for indicating the various tests to be performed. The ordinarily-skilled practitioner will understand that the tests are normally performed in conjunction with the CCTA, but not necessarily so. For example, the Coronary Calcium Score is rapidly entering common use as a preliminary screening test for coronary artery disease. In an embodiment, as shown in FIG. 6, the menu of CT tests may include:

Coronary Calcium Score;

Coronary CT Angiogram;

with Coronary Graft patency;

with exclude aortic dissection; and

with exclude pulmonary embolism.

In an embodiment, multiple ones of the alternative tests may be selected. In an embodiment, one or more of the tests may be grayed-out, or otherwise inaccessible unless a certain other test is ordered. For Example, the last three alternatives are tests that are only performed incident to a CTA. Thus, if CTA is not selected, the three alternatives may remain grayed-out or otherwise unavailable until ‘Coronary CT Angiogram’ is selected.

In an embodiment, the menu also includes a user interface element, such as a pull-down menu, for indicating the date on which the referring physician ordered the CT test.

In an embodiment, as shown in FIG. 6, the Patient Info form 600 may also include a menu 617 titled ‘Indications for Scan’, with which the physician or other user may list the reasons for ordering the scan. As shown, the user can specify whether the symptoms are chronic or acute. In an embodiment, the menu 617 may include the following list of symptoms:

Angina;

Unstable;

Typical;

Atypical;

Chest pain;

Noncardiac;

Typical;

Atypical;

Dyspnea;

CHF;

Known CAD;

Abnormal Cardiovascular Test;

Equivocal Stress Test;

Syncope;

Pre-EP;

Pulmonary Vein Evaluation;

Coronary Vein Evaluation; and

Other.

The ‘Other’ field may be a user interface feature, such as a text box, for entering signs and symptoms that are not included in the menu 617. In an embodiment, the task of filling out the Patient Info form 600, and all other forms, can be greatly expedited, through the use of a ‘Presets’ feature, which is accessed by means of a user interface feature 603, such as a button or a tab. More will be said about the ‘Presets” feature herein below, but it allows the physician or other user to set default values for many of fields of the Patient Info form 600 and the other forms of the application. The fields are then pre-populated with the default values. When filling out the forms, the physician or other user need only modify those fields in which the patient's information deviates from the default. Thus, in much the same way that one simplifies the task of tuning a car radio, the user may greatly simplify the task of filling out the forms by using the ‘Presets’ feature.

In an embodiment, the Patient Info form may include a ‘Nurse’ tab 611, for accessing a nursing history sub-form 1300, shown in FIGS. 13a and b. Using the nursing history sub-form 1300 enables nursing personnel or other users to enter a nursing history.

As described above, use of the ‘Presets’ feature greatly eases the task of filling out the nursing history. In an embodiment, the Nursing History form may include:

Age >50;

Family History (MI age <55);

Diabetes;

Hypertension (BP >140/90 or on BP meds)

Dyslipidemia (see definition)

On meds (for dsylipidemia

Abnormal Coronary Calcium Score

Valve Disease;

Aortic;

Mitral;

Stenosis;

Regurgitation;

Other;

Surgery?;

Patient's Perception of Symptoms;

Chest Pain

Shortness of Breath

Asymptomatic;

Other;

Acute Myocardial Infarction;

Cardiac Catheterization;

Percutaneous Coronary Intervention;

Coronary Artery Bypass;

Congestive Heart Failure;

Cardiac Arrest;

Afib/flutter;

PVD;

ICD (Pacemaker of Defibrillator);

Cerebrovascular Accident (stroke);

COPD; and

Valve Disease.

As shown in FIGS. 13a and b, entry of the nursing history data may be by way of user interface features such as radio buttons, checkboxes or text boxes. As shown in FIG. 13b, a ‘yes’ answer may trigger a request for more information. For example, if ‘yes’ is answered for a cardiac catheterization, the form asks if the procedure took place within the last 12 months.

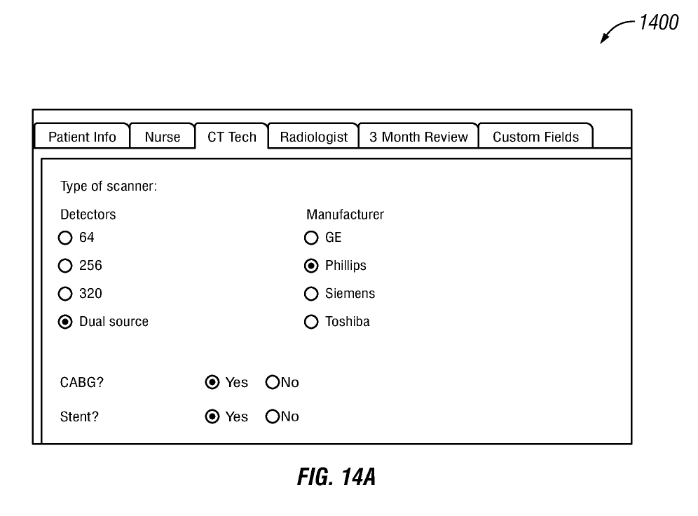

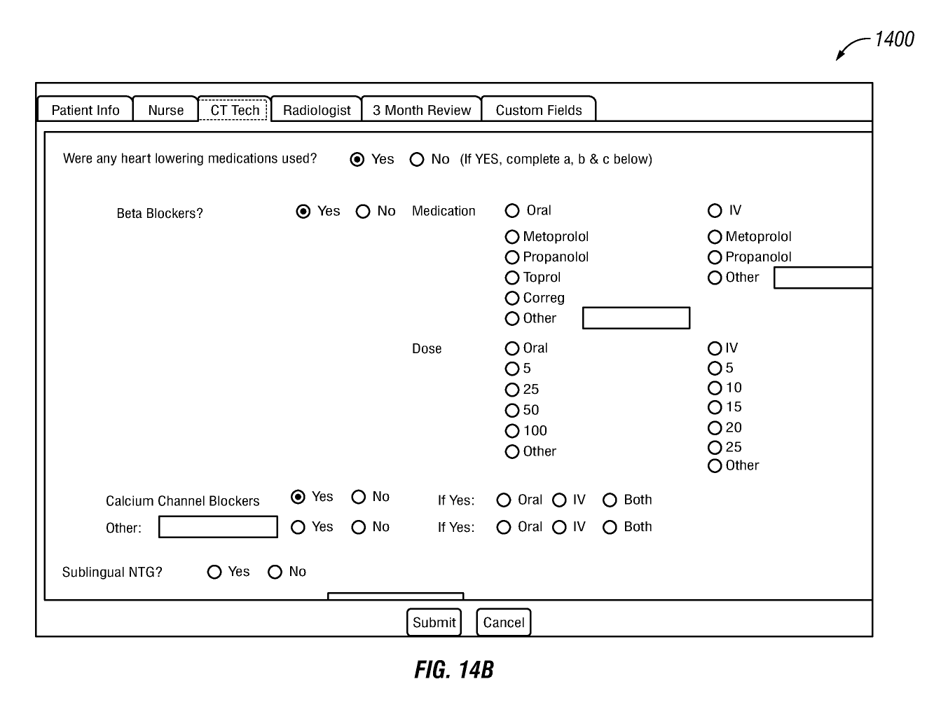

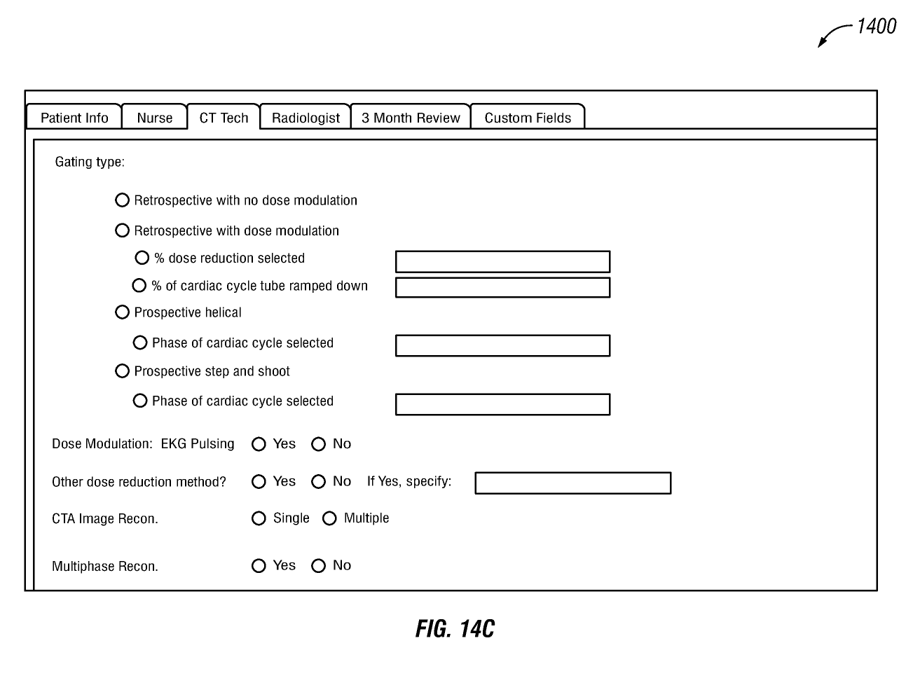

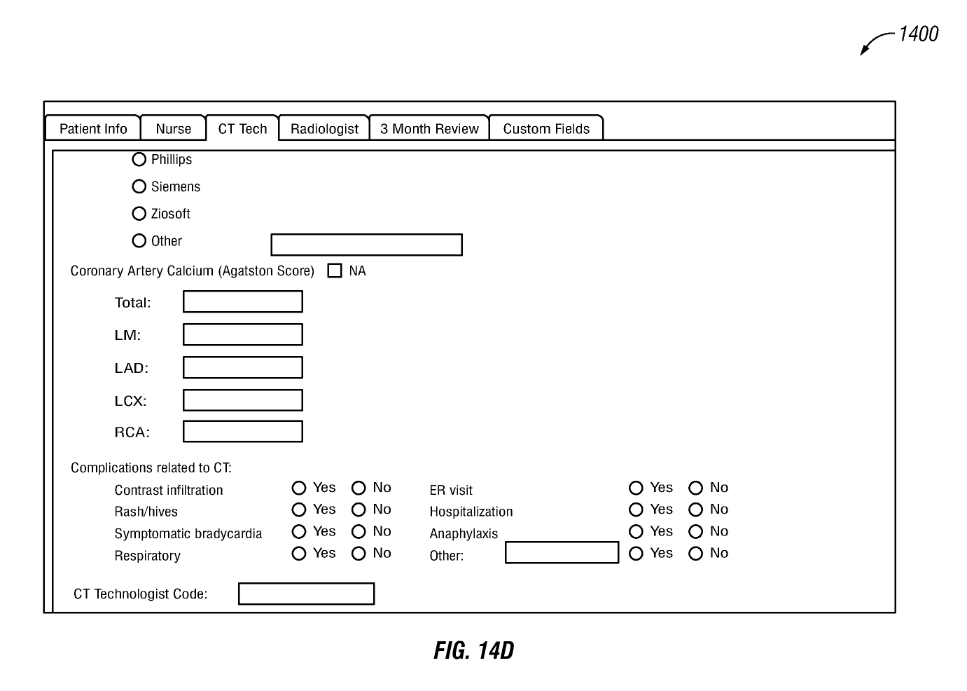

Turning now to FIGS. 14a-d, a number of views of a ‘CT Tech’ sub-page 1400 are shown. As in FIG. 6, the physician or other user may access the ‘CT Tech’ sub form 1400 from a tab 612 in the ‘Patient Info’ form 600. Technical personnel, such as a CT technologist may use the page 1400 to enter technical information regarding the scan itself and relevant patient history that could have a determinative effect on the procedure.

The ‘Presets’ feature, briefly described herein above, finds particular utility for the CT technologist. The form 1400 contains a large number of fields that must be completed, however, these data may be fairly repetitive, for example, the scanner type and the manufacturer. Accordingly, the CT technologist, in particular, may find the ‘Presets’ feature, which allows the CT technologist to create, in advance, a customized, pre-set technical standard, to be of great use.

As shown in FIG. 15, the user accesses the ‘Presets’ feature by selecting the ‘Presets’ button 603, whereupon a menu of options is shown, for example: ‘Normal’, ‘Custom Preset’, ‘Manage Custom Presets’, and ‘Clear All’. In order to create a Custom Preset, the user selects the ‘Custom Preset’ option. For all of the answers to be populated in advance, default values are specified. Typically, for a custom Preset, it would be most useful to pre-set variables having highly redundant values across the patient population. For example, in response to the question ‘Were heart rate lowering medications used?’, the user may specify commonly-used heart rate-lowering drugs, e.g. beta blockers, oral or IV, that nitro(glycerine) was used, test bolus, trigger bolus and so on. Thus, if the user, uses their ‘Preset’ to quickly answer these questions, anything that varies from the ‘Preset’ can be quickly identified and modifed. Thus, for example, if a calcium channel blocker was used and it was given orally, it can quickly be selected. Additionally, default values can simply be de-selected. After the Preset is designed, it can be named and saved. On subsequent uses, the ‘Preset’ can be selected from a menu of Presets accessed by selecting the ‘Manage Custom Presets’ option. Additionally, a Custom Preset can be designated as the default Preset and can be quickly accessed by selecting the ‘Normal’ option.

While the principles regarding the use of the ‘Preset feature’ have been described in relation to the CT Tech sub-form, they are readily taken advantage of by other users for all other elements of the system interface.

Returning now to FIGS. 14a-d, in an embodiment, the CT Tech form may include at least some of the following fields:

Type of scanner;

Manufacturer;

CABG?;

Stent?;

Were any heart rate lowering medications used?;

Beta blockers?

Dose;

Calcium Channel Blockers?;

Other;

Sublingual NTG?;

Gating Type;

Dose Modulation;

Other dose reduction method?;

CTA Image Recon;

Multiphase Recon;

Coronary Artery Calcium (Agatston Score);

Complications related to CT; and

CT Technologist Code.

As with other forms and sub-forms within the user interface, alternative values are selected by means of interface elements such as radio buttons, or check boxes.

Returning to FIG. 6, in an embodiment, the toolbar 601 may include a ‘Quality’ button 604. Assessing the quality of the scan is recommended by SCCT (Society of Cardiovascular Computed Tomography) as a preliminary step in CCTA interpretation. Selection of the ‘Quality’ button 604 navigates the physician to a form containing fields for assessing scan quality. In an embodiment the form includes fields at least for:

noise;

field of view;

contrast timing; and

artifact.

Accordingly, if there were a little noise in a study, the reading physician may specify that the study contained a moderate amount of noise. In addition, if the study quality so indicates, the physician may enter findings for the other parameters as well.

A further step in the study interpretation is to assess non-coronary findings. Generally, non-coronary findings may include findings related to pathologies of the valve, wall muscle of the heart, or valves. As in FIG. 6, the toolbar 601 may include a button or other UI feature 606 for accessing a form 700 for entering non-coronary findings. The form 700 provides a 2-dimensional graphical model 701 of the human heart. Additionally, the graphic contains a representation of the myocardial segment diagram 1100, also shown in FIG. 11. As the physician assesses the scan for non-coronary pathology, he/she uses the graphical model to enter non-coronary findings.

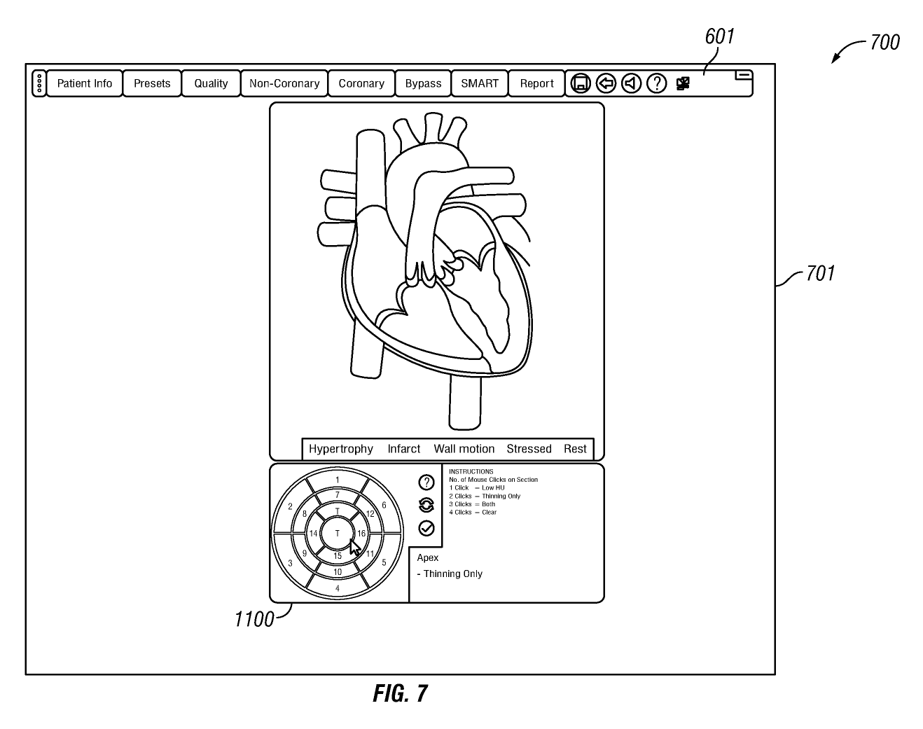

In the example of FIG. 7, the physician has first selected the menu option ‘hypertrophy’ to document a finding of ventricular hypertrophy; the physician then enters a finding of ‘[myocardial] thinning only’ in the apex of the myocardium. Looking at FIG. 11, one sees that area 17, in the exact center of the chart, represents the apex of the myocardium. The physician has then used a selection tool, a mouse, for example, to select the area of the chart representing the apex of the myocardium. In an embodiment, the number of mouse clicks the physician uses to select the chart area specifies the finding regarding the selected area. In this case, clicking twice identifies an area having thinning only, suggestive of ventricular hypertrophy. Other options include: a single click specifies an area having a low Hounsfield unit density; three clicks signifies thinning and low Hounsfield unit density and four clicks clears the segment. Additional menu options are ‘Infarct’, ‘Wall motion’, ‘Stressed’ and ‘Rest’. In a manner similar to that just described herein above, the user selects the parameter and then selects an area on the chart of myocardial segments and uses mouse-clicks to report specific findings from a menu of possible findings related to the parameter.

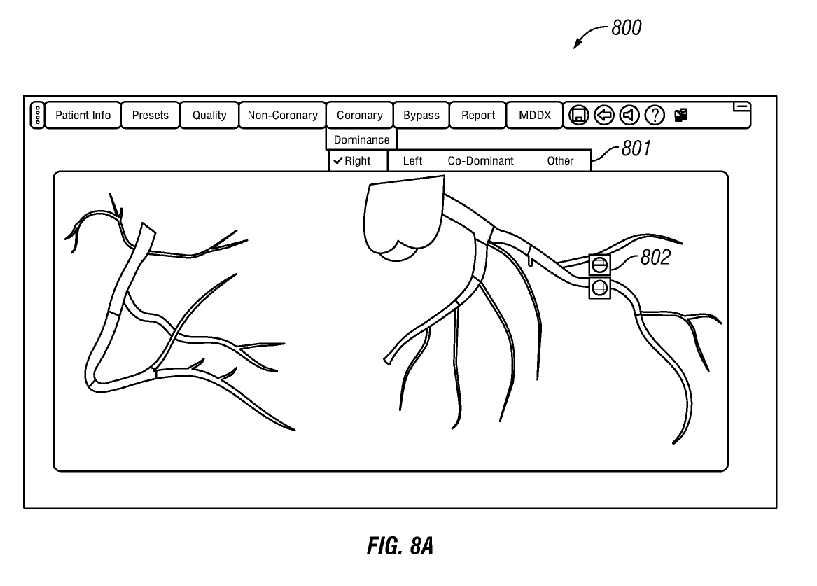

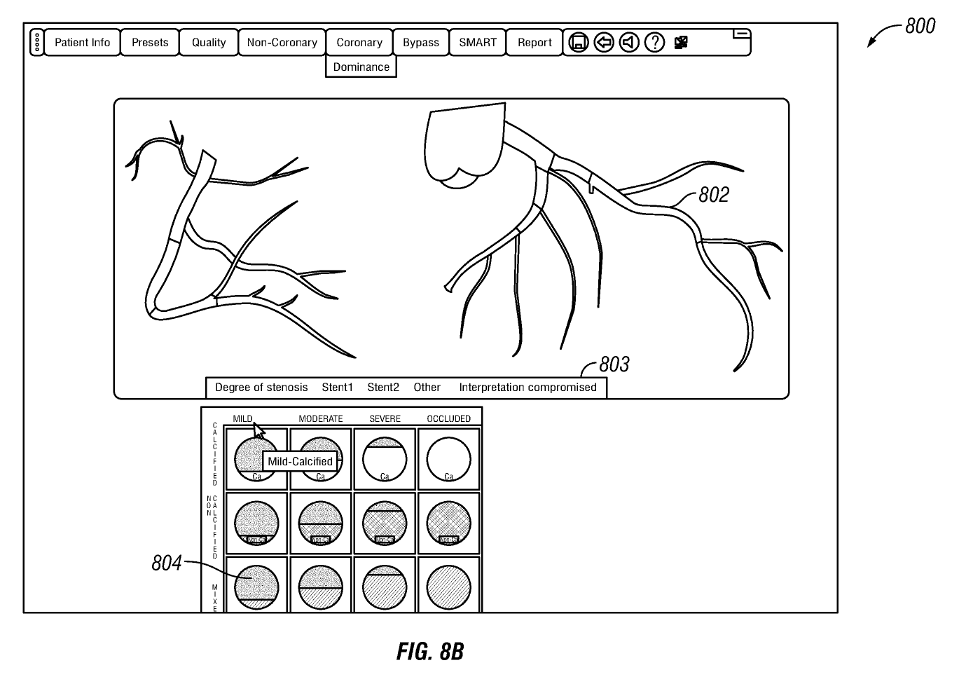

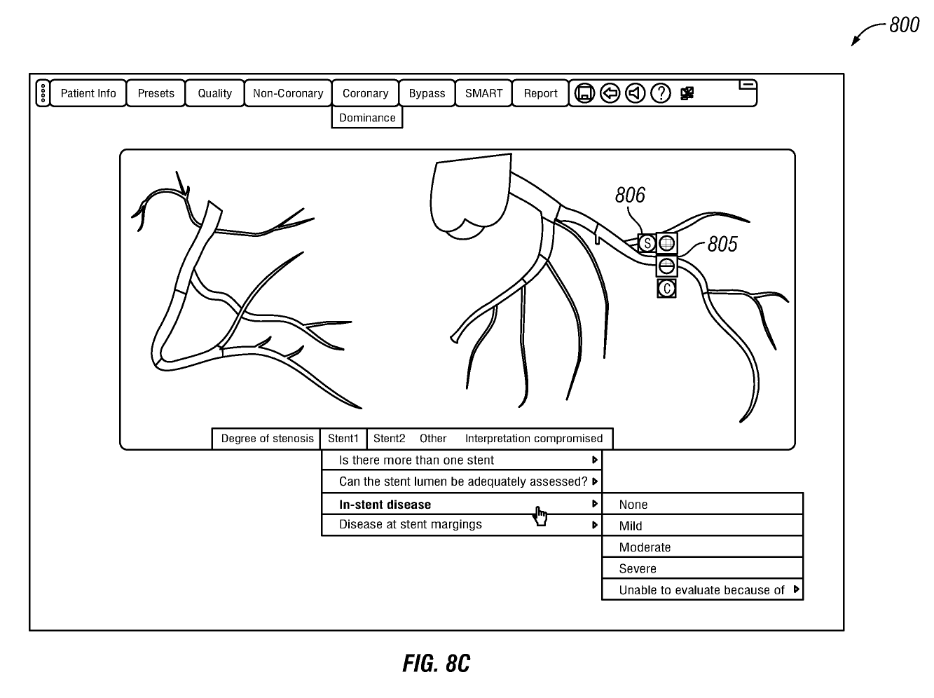

As in FIG. 6, in an embodiment, the toolbar 601 includes a UI element 606 for accessing a form 800 for reporting coronary findings, shown in FIGS. 8a-c. As shown in FIG. 8a, the form 800 includes a pull-down for naming the dominant coronary artery. Those of ordinary skill will recognize that the usual options are ‘Right’, ‘Left’, ‘Co-dominant’ and ‘Other’, for anomalous dominance configurations. As in FIG. 8, the user has selected ‘Right’. Those of ordinary skill will also recognize that the graphical representation of the coronary artery segments is in accordance with a 17-segment model endorsed by the American Heart Association. The various segments of the coronary arteries are selectable, for example, by clicking on the particular with the pointing device, a mouse for example. Here the user has selected the mid-LAD (left anterior descending) segment. Below the graphic of the coronary arteries is menu 803 of parameters that can be reported for the selected segment. As shown in FIG. 8b, in an embodiment the parameters may include one or more of:

Degree of stenosis;

Stent1;

Stent2;

Other; and

Interpretation compromised.

FIG. 8b shows the ‘Degree of Stenosis’ option having been selecting. Selecting this option triggers display of a colorimetric matrix 804 with which the user can report the degree and nature of the stenotic lesion observed in the vessel. Along the top row of the matrix, the options for reporting severity may be: ‘Mild’, ‘Moderate’, ‘Severe’ and ‘Occluded’. Along the left column of the matrix, the options for reporting the nature of the occlusion may be ‘Calcified’, ‘Non-calcified’ and ‘Mixed’, referring to the type of plaque responsible for narrowing the lumen of the vessel. Thus, one of twelve endpoints can be reported for each lesion reported. When the user selects one of the cells of the colorimetric matrix, a corresponding representation 805 of the cell is superimposed upon the selected vessel in the segment diagram, as shown in FIG. 8c. Thus, one viewing the patient's record can readily be informed of the degree and type of stenosis without consulting a textual record.

Also shown in FIG. 8c, it is possible for the user to report stents that are observed during the CCAT. The user may select the ‘Stent’ option from the menu 803, whereupon the user is presented with a series of questions to answer regarding the stent, for example:

‘Is their more than one stent?’;

‘Can stent lumen be adequately assessed?’;

‘In-stent disease?’; and

‘Disease at stent margins?’.

As each question is selected, the user is presented with a menu of answers to the questions. For example, here, the user has selected the question ‘In stent disease’, which triggered display of a pull-down of possible answers to the question: ‘None’, ‘Mild’, ‘Moderate’, ‘Severe’, ‘Unable to evaluate because of . . .’. Additionally, an icon 806 appears on the image of the selected arterial segment to indicate the presence of the stent.

Additional options in the form 800 are ‘Other’ and ‘Interpretation compromised’. ‘Other’ may be used for reporting significant findings that are, nonetheless, not readily categorized, such as congenital defects or tumors. ‘Interpretation compromised’ may be used for reporting conditions that have impaired the scan quality and have therefore interfered with interpretation, for example, excessive movement on the patient's part.

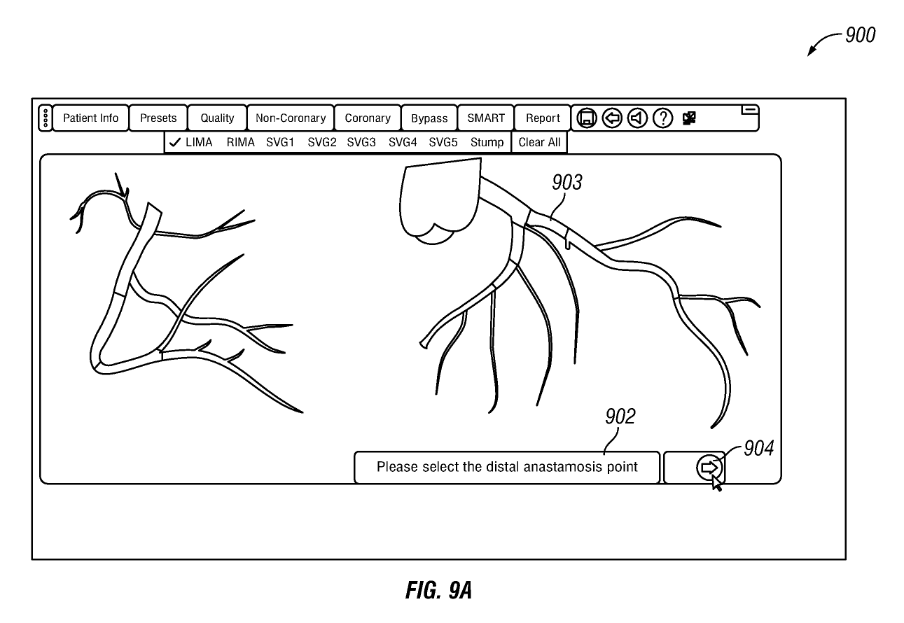

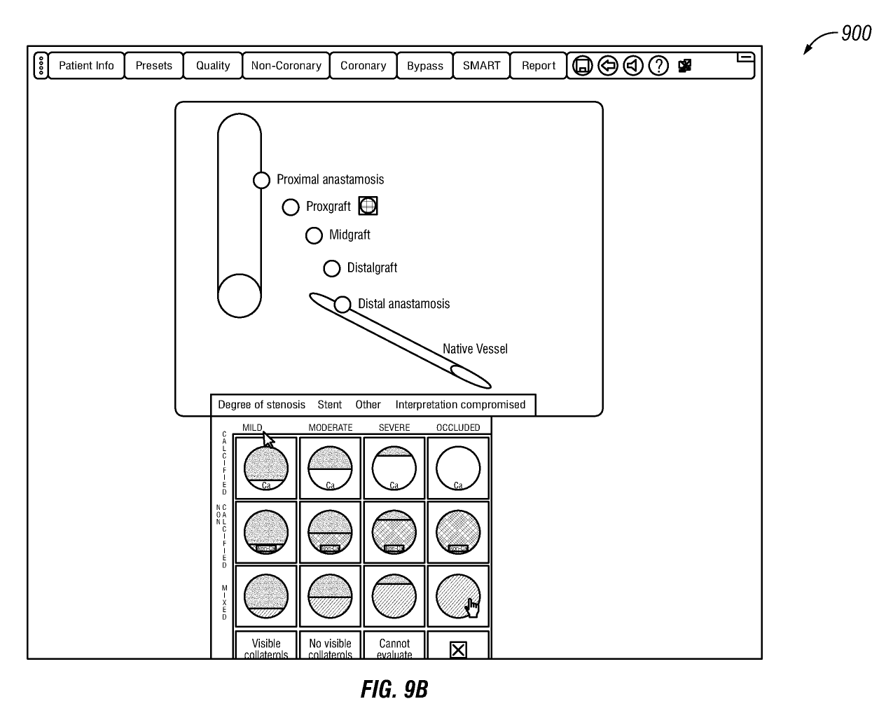

As shown in FIG. 6, the toolbar 601 includes a button 607 for entering bypass findings. Selection of the button 607 navigates the user to a form 900 for reporting bypass findings, as shown in FIG. 9a. The form 900 displays the same coronary artery segment diagram seen in the form 800 for reporting coronary findings. Here, the user, the user selects one or more coronary artery segments to specify coronary artery graft sites. Additionally, the form 900 includes a menu of graft types: for example: LIMA (left internal mammary artery); RIMA (right internal mammary artery) and SVG1-5 (saphenous vein grafts). The ordinarily—skilled practitioner will readily recognize that CABG procedures may commonly involve combinations of IMA grafts and saphenous vein grafts. In particular, a CABG procedure often involves several saphenous vein grafts, thus the software permits the user to report findings for multiple saphenous vein grafts. In the example of FIG. 9a, the user has selected ‘LIMA’ from the menu 901, indicating a LIMA vein graft. The software then displays a prompt 902 to the user to enter the distal anastamosis point; with the user selecting the mid-Left anterior descending artery by clicking it in the diagram 903 of coronary artery segments. After selecting the distal anastomosis point, selection of the arrow 904 then navigates the user to another view of the form 900, as shown in FIG. 9b. The same menu of findings that appears in the coronary findings form 800 appears in the form 900 to enable the user to report findings regarding the graft. Just as in the coronary findings form 800, selection of the ‘Degree of stenosis’ option causes display of the colorimetric matrix 804 for reporting stenosis. Here, the user has selected ‘proxgraft’ to specify the proximal portion of the graft and has selected ‘Degree of stenosis’ to report a stenotic lesion in the proximal portion of LIMA graft entered as in FIG. 9a. As previously described, the user selects the appropriate cell from the colorimetric matrix in order to specify the nature of the stenotic lesion. As in the coronary findings form 800, an icon is appended to the graphical representation of the proximal graft in order to indicate the presence of the stenotic lesion. The appearance of the icon duplicates the appearance of the selected cell from the matrix, creating a graphical representation of the findings reported, so that viewers need not consult textual data.

It will be appreciated that various permission levels can be configured for access to the various screens and forms of a patient record by the various parties involved in the delivery of care. For example, the physician and/or a system administrator may have ‘write’ access to all parts of the patient record. Other parties, such a nursing personnel, may only have ‘write’ access to the nursing history, while being granted ‘read-only’, access to other parts of the patient record. Additionally, certain personnel may be completely denied access to various portions of the patient record. For example, administrative personnel may be denied access to all but the patient's personal data. The ordinarily-skilled practitioner will readily understand that a permissions scheme is highly individual to the setting of use. Accordingly, the system provides great flexibility in setting permissions for the various members of the healthcare team.

Referring back now to FIG. 6, the ‘Patient Info’ form 600 includes a ‘Custom Fields’ tab 614. By selecting the ‘Custom Fields’ tab, the user is navigated to a form for configuring custom fields to be added to the ‘Patient Info’ form 600. For example, for a particular study, the principal investigator may wish to track which region of Brazil Brazilian patients come from. Using the ‘Custom Fields’ feature allows the user to configure fields for gathering the desired information. After the field is configured, it appears on the ‘Patient Info’ form 600.

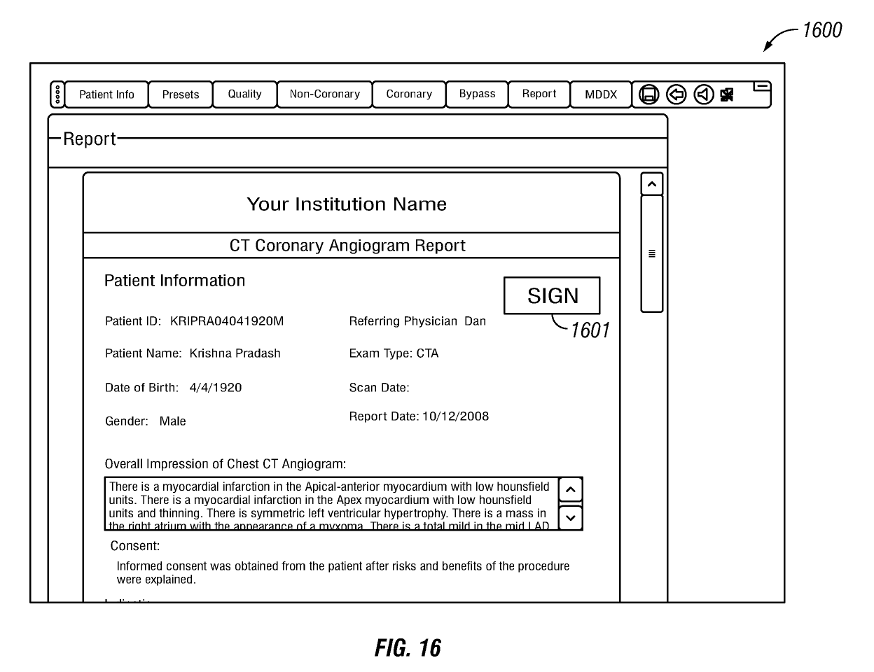

As shown in FIG. 16, the reporting process may culminate in generation of a text version 1600 of the report. As previously described, the report can be generated in a number of formats, for example various word-processing formats, or .PDF. The report can be printed or emailed and can also be imported into most common medical records systems. The electronic version of the report 1600 contains a ‘Sign’ button 1601 with which the physician may digitally sign the report 1600. Additionally, in other embodiments, a ‘Sign’ button may be provided on other of the forms with the application.

The combination of LAD and RAD functions with the CCTA reporting functionality greatly enhances the accuracy of diagnosis. The images that are being read can have as many as 9000 possible findings and take as long as forty-five minutes to read. The end goal of the system is to help the reading physician refine his/her diagnosis, thus, improving his/her diagnostic accuracy.

The MDDX CCTA report engine has the advantage that it is comprehensive: it has over nine thousand potential findings one can select in a structured reporting format. Secondly, the user only has to click what is abnormal. The program automatically defaults to ‘normal’. Thus, if there is a normal finding, the user doesn't have to click on that answer. Thirdly, the program generates a report in any of a number of formats, such as MICROSOFT WORD or PDF (portable document format). The report that can be imported into any electronic medical record system. The report can also be can e-mailed or printed. Additionally, it allows the process of interpreting CCTA to be guided by expert knowledge and a registry database of previously-interpreted CCTA studies. Finally, relating to utility for scientific study, a searchable database of codified findings is created.

Embodiments may include a system, apparatus, methods for using the system and for interpreting advanced visualization images, a user interface to the system, and at least one computer program product comprising a tangible computer-readable medium having computer-readable instructions embodied thereon.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

1. An expert system for interpreting advanced visualization images comprising:
a data-processing device;
a database of medical logic;
a registry database comprising previously-reported interpretations of advanced processing visualization images; and
a computer program, executing on said data-processing device, comprising instructions for receiving a preliminary interpretation of at least one first advanced visualization image from said interpreter, formatting and coding said preliminary interpretation according to at least one predetermined standard and comparing said interpretation of said at least one first advanced visualization image with said database of medical logic and said registry database;
wherein execution of said instructions assists an interpreter in interpretation of said at least one first advanced visualization image by reporting results of said comparing to said interpreter.

2. The system of claim 1, further comprising:
a user interface for reporting findings of said interpretation of said at least one first advanced visualization image by said interpreter;
a database of patient records for storing said formatted and coded interpretation; and
a server, communicatively coupled to said data-processing device and housing said registry database, wherein said registry database comprises previous interpretations of advanced visualization images that have been de-identified by stripping them of patient-identifying personal data, said server operative to manage authentication and permissions for said system;
wherein said database of patient records and said registry database are synchronized at predetermined intervals to transfer new patient records to said registry database after being de-identified.

3. The system of claim 1, wherein said data-processing device comprises one of:
a workstation for rendering 3-D images from CCTA (cardiac computed tomography angiogram) data; and
a client machine communicatively coupled to said workstation.

4. The system of claim 1, wherein said database of medical logic comprises a rulebase containing rules embodying expert knowledge relating to interpretation of CCTA (cardiac computed tomography angiogram) images, wherein said instructions for comparing said interpretation of said at least one first advanced visualization image comprise instructions for:
evaluating a received interpretation of a first CCTA image to evaluate whether at least one condition specified by a rule is true;
responsive to a determination that said at least one condition is true, determining if at least one conclusion specified by said rule is true;
responsive to a determination that said at least one condition is not true, displaying a prompt to said interpreter of a result of said comparing.

5. The system of claim 1, wherein said instructions for comparing said interpretation of said at least one first advanced visualization image with said registry database comprise instructions for:
querying said patient registry based on an interpretation of at least one first CCTA image to identify trends in patient data relevant to said interpretation of said at least one first CCTA image; and
reporting any data retrieved back to said interpreter.

6. The system of claim 2, wherein said user interface comprises one or more of:
at least one element for entering patient-related data;
at least one element for entering non-coronary findings;
at least one element for entering coronary findings;
at least one element for entering bypass findings;
at least one element for initiating said comparing;
at least one element for generating a textual report of said interpretation of said at least one first advanced visualization image;
at least one element for reporting quality of said at least one first advanced visualization image;
at least one element for specifying at least one preset user interface configuration; and
at least one element for generating a pre-formatted, codified report of said interpretation; and
at least one toolbar for accessing said elements.

7. The system of claim 6, wherein said at least one element for entering patient-related data comprises at least one of:
at least one element for entering patient-identifying data;
at least one element for entering a nursing history;
at least one element for entering technical data regarding an imaging procedure;
at least one element for entering an over-read interpretation;
at least one element for entering a follow-up review; and
at least one element for configuring one or more custom fields.

8. The system of claim 6, wherein said at least one element for entering non-coronary findings comprises at least one graphical element for specifying at least;
at least one predetermined region of a patient's myocardium and identifying at least one noteworthy condition regarding said at least one predetermined region of said myocardium.

9. The system of claim 6, wherein said at least one element for entering coronary findings comprises at least one graphical element for selecting at least one segment of at least one coronary artery and identifying at least one noteworthy condition regarding said at least one segment of said at least one coronary artery.

10. The system of claim 6, wherein said at least one element for entering bypass findings comprises at least one graphical element for specifying type and site of at least one CABG (coronary artery bypass graft) and identifying at least one noteworthy condition regarding said at least one CABG.

11. The system of claim 6, wherein said at least one element for specifying at least one preset user interface configuration comprises at least one element for specifying at least one default value for pre-populating at least one field of a patient record.

12. The system of claim 6, wherein said preformatted, codified report of said interpretation comprises an electronic representation of a textual report that includes a user interface element for digitally signing said report, wherein activation of said user interface element for digitally signing said report by said interpreter establishes a reporting date and affixes the interpreter's digital signature to said report; and
wherein said report is formatted in a plurality of word-processing and document exchange formats;
wherein said report is printable and sendable by email; and
wherein said report is compatible with at least one medical records system (MRS).

13. In an expert system for interpreting advanced visualization images comprising a data-processing device, a medical logic database and a patient registry and executing a software application for reporting interpretation of said images, a user interface for reporting interpretation of said images comprising:
at least one element for entering patient-related data;
at least one element for entering non-coronary findings;
at least one element for entering coronary findings;
at least one element for entering bypass findings;
at least one element for initiating comparison of a preliminary interpretation of at least one of said images with said medical logic database and said patient registry; and
at least one element for generating a textual report of said interpretation of said at least one of said advanced visualization images.

14. The user interface of claim 13, wherein said at least one element for entering patient-related data comprises:
at least one element for entering patient-identifying data;
at least one element for entering a nursing history;
at least one element for entering technical data regarding an imaging procedure;
at least one element for entering an over-read interpretation;
at least one element for entering a follow-up review; and
at least one element for configuring one or more custom fields.

15. The user interface of claim 13, wherein said at least one element for entering non-coronary findings comprises at least one graphical element for specifying at least;
at least one predetermined region of a patient's myocardium and identifying at least one noteworthy condition regarding said at least one predetermined region of said myocardium.

16. The user interface of claim 13, wherein said at least one element for entering coronary findings comprises at least one graphical element for selecting at least one segment of at least one coronary artery and identifying at least one noteworthy condition regarding said at least one segment of said at least one coronary artery.

17. The user interface of claim 13, wherein said at least one element for entering bypass findings comprises at least one graphical element for specifying type and site of at least one CABG (coronary artery bypass graft) and identifying at least one noteworthy condition regarding said at least one CABG

18. The user interface of claim 13, wherein said report comprises a preformatted, codified report of said interpretation in an electronic representation of a textual report that includes a user interface element for digitally signing said report, wherein activation of said user interface element for digitally signing said report by said interpreter establishes a reporting date and affixes the interpreter's digital signature to said report; and
wherein said report is formatted in a plurality of word-processing and document exchange formats;
wherein said report is printable and sendable by email; and
wherein said report is compatible with at least one medical records system (MRS).

19. The user interface of claim 13, further comprising;
at least one element for reporting quality of said at least one first advanced visualization image;
at least one element for specifying at least one preset user interface configuration;
at least one element for generating a pre-formatted, codified report of said interpretation; and
at least one toolbar for accessing said elements.

20. In an expert system for interpreting advanced visualization images comprising a data-processing device, a medical logic database and a patient registry and executing a software application for reporting interpretation of said images, a method of using said system comprising the steps of:
entering patient related data;
responsive to identification of at least one coronary finding, entering said at least one identified coronary finding;
responsive to identification of at least one non-coronary finding, entering said at least one identified coronary finding;
responsive to identification of at least one bypass finding, entering said at least one bypass finding;
comparing a preliminary interpretation of at least one of said images with said medical logic database and said patient registry; and
generating a textual report of said interpretation of said at least one of said advanced visualization images.

21. The method of claim 20, wherein an advance visualization image comprises a CCTA image.

22. The method of claim 20, wherein said report comprises a preformatted, codified report of said interpretation in an electronic representation of a textual report that includes a user interface element for digitally signing said report, wherein activation of said user interface element for digitally signing said report by said interpreter establishes a reporting date and affixes the interpreter's digital signature to said report; and
wherein said report is formatted in a plurality of word-processing and document exchange formats;
wherein said report is printable and sendable by email; and
wherein said report is compatible with at least one medical records system (MRS).

23. The method of claim 20, wherein said database of medical logic comprises a rulebase containing rules embodying expert knowledge relating to interpretation of CCTA (cardiac computed tomography angiogram) images and wherein said step of comparing said interpretation of said at least one first advanced visualization image comprises the steps of:
evaluating a received interpretation of a first CCTA image to evaluate whether at least one condition specified by a rule is true;
responsive to a determination that said at least one condition is true, determining if at least one conclusion specified by said rule is true;
responsive to a determination that said at least one condition is not true, displaying a prompt to said interpreter of a result of said comparing.

24. The method of claim 20, wherein said step of comparing said interpretation of said at least one first advanced visualization image with said registry database comprises the steps of:
querying said patient registry based on an interpretation of at least one image to identify trends in patient data relevant to said interpretation of said at least one first image; and
reporting any data retrieved back to said interpreter.

25. A computer program product comprising computer-readable instructions embodied on a tangible computer-readable medium which, when executed, implement an expert system for interpreting advanced visualization images, said expert system comprising:
a data processing device;
an expert program for interpreting said advanced visualization images executing on said data processing device;
a database of medical logic; and
a patient registry communicatively coupled to said data processing device;
wherein said expert program evaluates reported interpretations of said advanced visualization images against said medical logic database and queries said patient registry for data related to said interpretation.
